(19) United States
(12) Patent Application Publication
(10) Pub. No.: US 2007/0204245 A1
(43) Pub. Date: Aug. 30, 2007

(54) Method for accelerating the RC extraction in integrated circuit designs

(75) Inventors: Dimitris K. Fotakis, Saratoga, CA (US); Bill Scott, Sunnyvale, CA (US); Mattias Hembruch, Fremont, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Athena Design Systems, Inc.

(21) Appl. No.: 11/500,727

(22) Filed: Aug. 7, 2006

Related U.S. Application Data
(60) Provisional application No. 60/776,494, filed on Feb. 24, 2006.

(51) Int. Cl. G06F 17/50

(52) U.S. Cl. 716/5; 716/7

(57) ABSTRACT

The present invention provides a system and method for accelerating the resistance and capacitance (RC) extraction process by performing parallel and distributed processing. The method includes the dividing of a given integrated circuit (IC) design into a limited number of non-overlapping tile blocks, distributing tile blocks to standard RC extraction tools, and processing all tiles in parallel by these tools. A tile block includes all information for performing accurate RC extraction. Thereafter, resulting parasitic RC information is assembled to form a complete parasitic RC model for the entire IC.

### CROSS-REFERENCE TO RELATED APPLICATION

This application claims the benefit of U.S. Provisional Patent Application No. 60/776,494 filed Feb. 24, 2006.

### BACKGROUND OF THE INVENTION

1. Field of the Invention

The invention relates generally to methods for analyzing integrated circuit (IC) designs, and more particularly to methods for accelerating the RC extraction process in complex IC designs.

2. Prior Art

Due to the ever increasing complexity of integrated circuit (IC) designs, IC designers become more and more reliant on electronic design automation (EDA) tools. An IC is fabricated through a series of lithographic steps that may be abstracted as a construction of a multi-layered stack of materials, each layer consisting of a large set of simple geometries.

Generally, the processing steps taken by an EDA tool to obtain an IC layout are: a) mapping of an IC logic to existing blocks and further partitioning a circuit into blocks of modules or sub-circuits; b) floor planning that defines the alignment and relative orientation of the circuit blocks; c) placement that determines more precisely the positions of the circuit blocks and their component blocks; d) routing, which completes the interconnects among electrical components; and e) verification, which checks the layout to ensure that it meets design and functional requirements.

The place and route tools generate an IC layout indicating the position of each circuit block (or a cell) within the IC. Further indicated are the nets' interconnections of the cells. A set of terminals to be connected is commonly known as a net. The nets include conductors (wires) formed on one or more layers of the IC and may include buffers for amplifying signals as they travel between cells.

Once the IC layout is ready, resistance and capacitance of the various arcs (or segments) of each net are determined using a conventional resistance and capacitance (RC) extraction tool. A net may have many arcs for which the RC extraction tool separately calculates impedance values. For example, FIG. 1 illustrates a net 100 composed of six arcs 110-1 through 110-6 for which resistance and capacitance values are separately estimated. Vias 120-1, 120-2, and 120-3 link arcs residing on different layers. Vias 120 may be treated as separate arcs.

Each arc 110 is a conductor having an amount of resistance per unit length that is mainly a function of the cross-sectional area of the conductor. The amount capacitance per unit length of the conductor is a function of the width of the conductor, the distance from the conductor to nearby power and ground planes and to other conductors, and the dielectric constant of the insulating material between the conductor and power and ground planes. Thus, a RC extraction tool estimates the impedance of each arc based on the structure of the conductor forming the arc and on characteristics of the surrounding portions of the IC that influence its capacitance.

A conventional RC extraction tool stores the extracted parasitic RC values, and RC networks thereof, it generates for each arc of a net in a database accessible to a timing verification tool. The verification tool computes the time delays of signal paths to determine whether the layout meets various timing constraints on those signal paths. When path delays of one or more signal paths fail to meet timing constraints, the layout design is revised to reduce delays in those signal paths. Parasitic data can be represented on a net-by-net basis in many different levels of sophistication, from a simple lumped capacitance to a fully distributed RC tree. Parasitic data may be transferred and saved in a standard parasitic exchange format (SPEF). The SPEF provides a standard medium to pass parasitic information between EDA tools during any stage of the design.

As a typical IC consists of millions of nets, each of which may include several arcs, the execution of the RC extraction process by conventional tools is a time consuming task. In addition, this fact indicates a potential of extremely high demands on computational resources. Therefore, it would be advantageous to provide a solution for accelerating the RC extraction process in IC designs.

### BRIEF DESCRIPTION OF THE DRAWINGS

FIG. 1 is a simplified plan view of a net (prior art).

FIG. 2 is a flowchart describing the method for accelerating the RC extraction process in accordance with one embodiment of the present invention.

FIGS. 3A, 3B, 3C and 3D are schematic diagrams of an IC design used to exemplify the techniques of the disclosed method.

FIG. 4 is a flowchart describing the method for tiling an IC design in accordance with one embodiment of the present invention.

FIG. 5 is a flowchart describing the process for partitioning the IC connectivity.

FIG. 6 is a distributed multi-processing system utilized in accordance with the present invention.

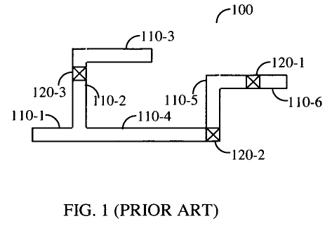

### DETAILED DESCRIPTION OF THE PREFERRED EMBODIMENTS

To overcome the limitations discussed in the prior art, there is disclosed a system and method thereof for accelerating the resistance and capacitance (RC) extraction process by performing parallel distributed processing of sub-tasks. The method includes dividing a given integrated circuit (IC) design into a limited number of non-overlapping tile blocks, distributing tile blocks to standard RC extraction tools, and processing all tiles in parallel by these tools. A tile block includes all information that allows for performing accurate RC extraction. Thereafter, parasitic RC network values are assembled to form a complete solution for the entire IC.

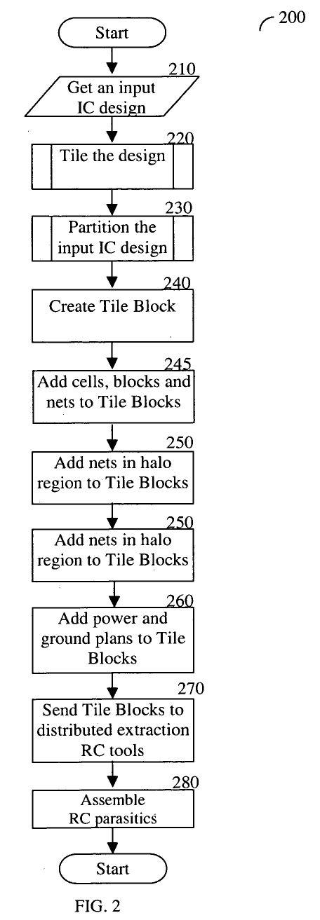

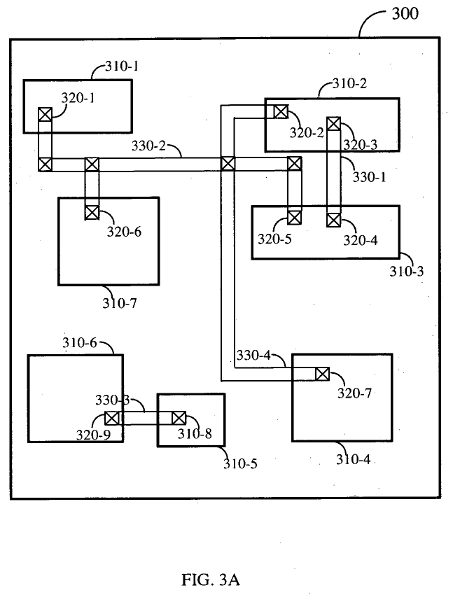

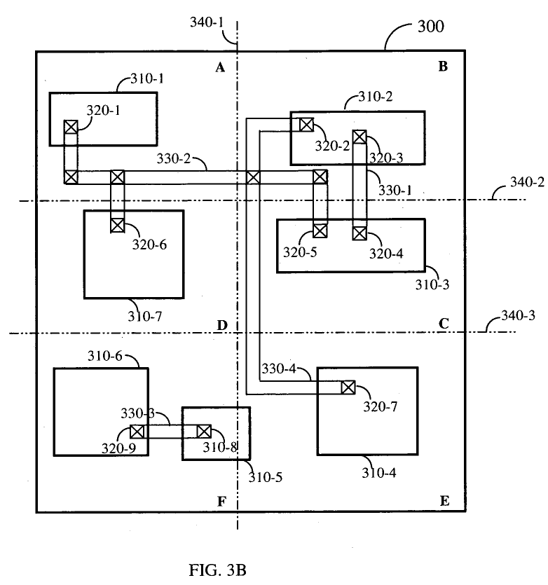

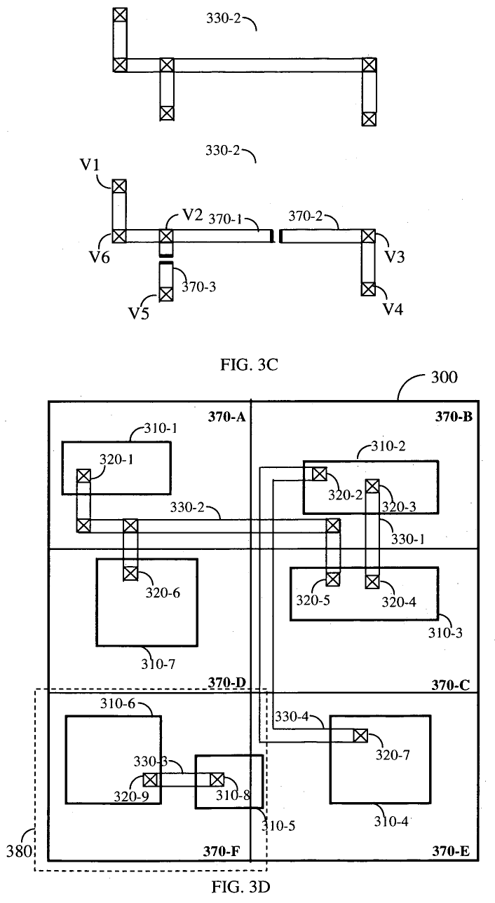

FIG. 2 shows an exemplary and non-limiting flowchart 200 describing the method for accelerating the RC extraction process in accordance with one embodiment of the present invention. At 210, the files of a routed IC design are received. The input design may be a result of a detailed or global routing tool. FIG. 3A shows an exemplary IC layout 300 used to describe the techniques of the disclosed method. IC 300 includes seven cells 310-1 through 310-7. Each cell 310 may represent a single logic element, such as a gate, or several logic elements interconnected in a standardized manner to perform a specific function. Each of cells 310 has at least one terminal (or a port) 320, each of which may be connected, by conductors (wires), to one or more other terminals 320 of IC 300. The conductors connecting the terminals of the IC are also formed on the surface of the IC. IC 300 includes four nets 330-1 through 330-4. Net 330-1 comprises terminals 320-3 and 320-4, net 330-2 consists of terminals 320-1, 320-5, and 320-6, net 330-3 includes terminals 320-8 and 320-9, and nets 330-4 consist of terminals 320-2 and 320-7. A cell may further include one or more output and input terminals (not shown in FIG. 3A).

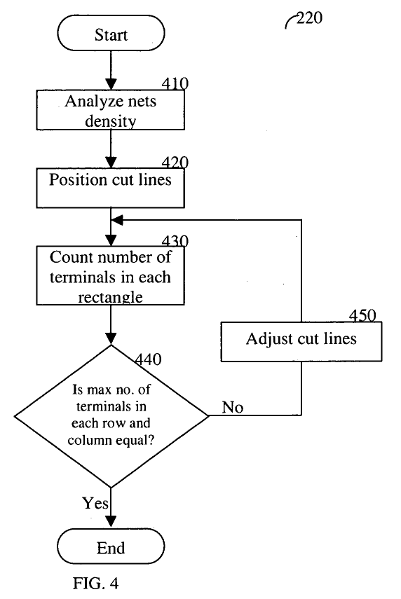

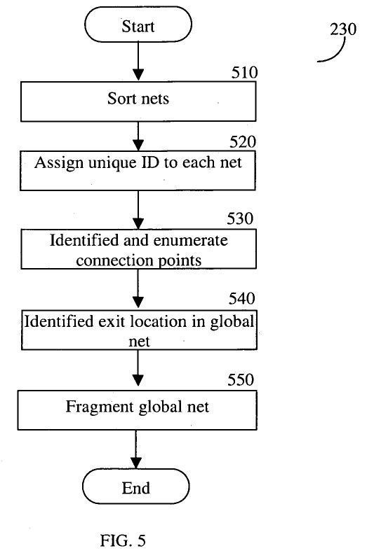

At 220 the input design is divided to non-overlapping tiles. Referring now to FIG. 4 the execution of the tiling for RC extraction task is described in greater detail. At 410, the input design is processed to determine the density of nets in the layout. This is performed to optimize the number of wires being cut and minimize the run time of the tiling task. At 420, a predefined number of horizontal and vertical cut lines are positioned in the layout within predefined intervals. The initial positions are determined according the density analysis. For example, if an area that does not include nets is detected, a cut line is not placed there. The number of cut lines may be a function of the size of the design, number of nets, and so on. FIG. 3B shows IC 300 that includes a vertical cut line 340-1 and horizontal cut lines 340-2 and 340-3. As can be seen, cut lines 340 form six rectangles labeled A, B, C, D, E, and F. At 430, the number of terminals in each rectangle is counted. For example, rectangle-A includes one terminal and rectangle-B includes two terminals. At 440, a check is performed to determine if the maximum number of terminals in each row and each column are approximately equal. For example, the maximum number of terminals in each row and column of the IC shown in FIG. 3B is two. If 440 results in a negative answer, execution continues with 450; otherwise, the rectangles are determined to be the tiles. A quantitative measure of “approximately equal” in absolute terms may be established ahead of time by preference of experience, or alternatively, established in relative terms as a fractional or percentage difference limitation between the maximum number of terminals in each row and each column. At 450, the position of the cut lines is adjusted and execution returns to 430. Steps 430 through 450 are repeated until the condition checked at 440 is satisfied. It should be noted that the method avoids positioning cut lines (i.e., cutting the area) where a net connects to a terminal of a cell.

Referring back to FIG. 2, at 230 the IC connectivity is partitioned based on the constructed tiles. FIG. 5 shows the execution of 230 in greater detail. At 510, all nets in the input IC design are sorted into two groups: local and global. A local net is entirely bounded in a single tile, whereas a global net resides in two or more tiles. For example, net 330-3 is local and net 330-4 is global. At 520, each global and local net is assigned a unique identification (ID) number. At 530, in each net, junction points (i.e., vias) are identified and assigned with a unique ID number. At 540, exact positions of exit locations of each global net on the boundaries of each tile are identified. A detailed description of this task may be found in U.S. patent application Ser. No. 11/357,823 entitled “Method for Tiling Integrated Circuit Designs” assigned to the common assignee and is hereby incorporated by reference for all that it contains. At 550, global nets are fragmented into fragments, where exit locations and terminals of a given net inside a tile form a new net “tile net”. The tile net gets the ID number of the respective global net while the point IDs of vias remain unchanged. This is performed in order to preserve the ordering of a wire as it breaks up to nets. As an example, FIG. 3C shows global nets 330-2 before and after being divided into three tile nets 370-1 through 370-3. Each tile net preserves the vias and point IDS labeled V1 through V6.

Reference now returns to FIG. 2, where at 240, for each identified net a tile block is created. At 245, all cell and block instances that intersect the tile boundaries together with the local nets and tile nets for the tile are copied to the created tile block. At 250, pieces of nets that lie in a thin halo region (e.g. 5 microns wide) outside the tile and surrounding the tile are added to the respective tile block. These pieces of nets are needed as part of the environment for extracting the nets inside the tile. An exemplary tile block is shown in FIG. 3D. At 260, the parts of the power and ground planes that intersect the tile region or the halo region are copied to the respective tile block. That is, a tile block includes all information covered by a tile and its halo region. This allows the performance of accurate RC extraction. At 270, each tile block is sent to a standard RC extraction tool. This allows the processing of up to all, or at least two tiles, on a set of distributed extraction tools simultaneously. In one embodiment of the disclosed invention each tile block is sent to an RC extraction tool that is most suitable to the determined characteristics of the tile. At 280, once the RC extraction of each tile is completed, its resulting parasitic values are received (e.g., in a SPEF) and assembled together to allow the performance of at least timing analysis by a timing verification tool. It should be appreciated by a person skilled in the art that by processing the tiles independently and simultaneously, the time required for completing the RC extraction task is reduced typically by an order of magnitude.

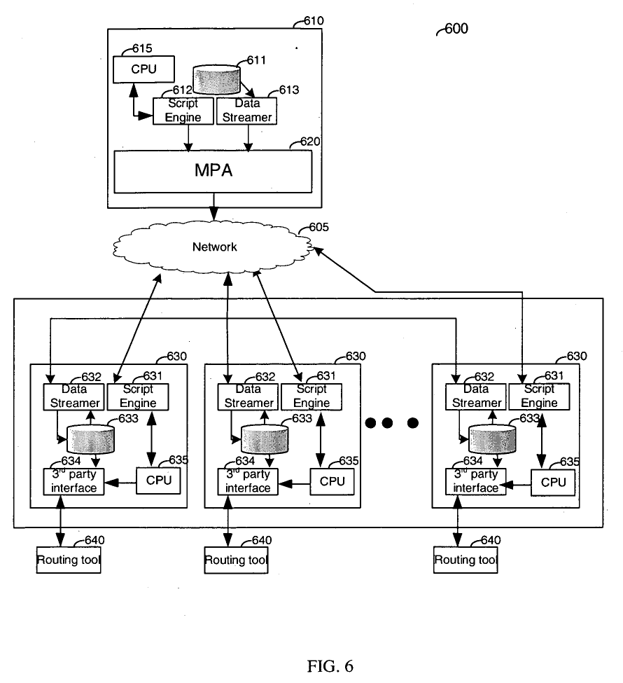

FIG. 6 shows a diagram of an exemplary distributed multi-processing system 600 that can be utilized to execute the tiling for the purpose of the RC extraction process disclosed herein. System 600 comprises a main computing node 610 and a plurality of distributed remote processing nodes 630. The main computing node 610 includes a main database 611 for holding design information, a script engine 612 for propagating scripts to be executed by remote processing nodes 630, a data streamer 613 for transferring binary data streams to remote processing nodes 630, and a multi-processing agent (MPA) 620. MPA 620 is the infrastructure that enables the distributed parallel processing. Specifically, MPA 620 manages the distributed processing recourses and the transfers of plurality of data streams from and to remote processing nodes 630. In addition, main computing node 610 preferably includes a central processing unit (CPU) 615 for executing various processing tasks.

Each of remote processing nodes 630 includes a remote script engine 631, a remote data streamer 632 for receiving and transforming data streams, a remote database 633 for maintaining blocks and cells' information, and a third party interface 634. The third party interface 634 interfaces with at least a router 640. A remote processing node 630 preferably includes a CPU 635 having its own operating system and being capable of performing various processing tasks. Remote processing nodes 630 are part of a computer farm where workload management for achieving the maximum utilization of computing recourses is performed by MPA 620. The communication between main computing node 610 and a remote processing node 630 is performed over a network 605. The architecture and the operation of system 600 is described in greater detail in U.S. patent application Ser. No. 11/315,892 entitled “System for Performing Parallel Distributed Processing for Physical Layout Generation” assigned to the common assignee and is hereby incorporated by reference for all that it contains.

In accordance with the present invention, the methods, discussed in greater detail above, are executed by main processing node 610. That is, main processing node 610 breaks an IC design, saved in main database 611, into non-overlapping tile blocks. Each tile block is transferred as a data stream to remote processing nodes 630 and saved in remote databases 633. Each of nodes 630 receives the data stream that encapsulates tile information and sends this information in a standard format (e.g., LEF, DEF, etc.) to an extraction tool 640. The distribution of tasks to remote processing nodes 630 is performed by MPA 620 in a way that ensures optimized performance and load-balancing. Once the processing of a tile has completed, the computed RC parasitic data is sent back to respective node 630 and saved in databases 633. Subsequently, parasitic RC values from all remote nodes are sent back to main computing node 610 as a data stream, assembled and saved in main database 611. The assembly of the parasitic RC nets is done while preserving the order of wires. This is achieved by using the IDs giving to nets and connection points.

While a preferred embodiment of the present invention has been disclosed and described herein for purposes of exemplary illustration and not for purposes of limitation, it will be understood by those skilled in the art that various changes in form and detail may be made therein without departing from the spirit and scope of the invention.

What is claimed is:

1. A method for accelerating the resistance and capacitance (RC) extraction process of integrated circuit (IC) design, said method comprising:
tiling an input IC design into a limited number of non-overlapping tiles;
partitioning the connectivity of said input IC design according to said tiles; and
creating tile blocks, wherein each said tile block includes extraction information for performing the RC extraction.

2. The method of claim 1, further comprising:
distributing said tile blocks to a plurality of distributed RC extraction tools;
simultaneously processing said tile blocks by said plurality of distributed RC extraction tools; and
assembling resulting parasitic RC to form a complete parasitic RC model for the IC design.

3. The method of claim 2, wherein tiling said input IC design comprises:
determining the density of nets in said input IC design;
based on the nets' density, determining the position of vertical and horizontal cut lines in the IC design, and thereby forming a plurality of rectangles;
counting the number of terminals in each rectangle;
determining if a maximum number of terminals in each row and each column in the plurality of rectangles are approximately equal; and
repositioning said vertical and horizontal cut lines if said maximum number of terminals in each row and each column in the plurality of rectangles are not approximately equal.

4. The method of claim 3, wherein the rectangles determined by the final position of said vertical and horizontal cut lines are said tiles.

5. The method of claim 1, wherein partitioning the connectivity of said input IC design comprises:
sorting nets in said IC design into local nets and global nets;
assigning a unique identification (ID) number for each of said local nets and global nets;
assigning a unique ID number for each connection point in each of said local nets and global nets;
identifying exact positions of exit locations of said global nets on boundaries of each of said tiles;
fragmenting each of said global nets into fragments; and
forming a tile net for each exit location and each terminal in each of said global nets inside each of said tiles.

6. The method of claim 5, wherein each of said global nets resides in a respective plurality of said tiles.

7. The method of claim 5, wherein each of said local nets resides within a respective one of said tiles.

8. The method of claim 5, wherein said tile net is assigned a unique ID number of a respective global net.

9. The method of claim 1, wherein creating said tile blocks comprises:
for each net in each said tile, creating an instance of a tile block;
copying cell and block instances that intersect said tile boundaries to said instance of said tile block;
copying local nets and tile nets inside said tile to said instance of said tile block;
copying nets lie in a halo region of said tile to said instance of said tile block;
copying power and ground planes that intersect said tile to said instance of said tile block; and
copying power and ground planes that intersect said halo region to said instance of said tile block.

10. The method of claim 9, wherein said extraction information includes at least: cell and block instances that intersect the tile boundaries, local nets and tile nets, pieces of nets that lie in a halo region, and parts of the power and ground planes that intersect the tile region or the halo region.

11. A machine-readable medium that provides instructions to implement a method for accelerating the resistance and capacitance (RC) extraction process of integrated circuit (IC) design, which instructions, when executed by a set of processors, cause said set of processors to perform operations comprising:
tiling an input IC design into a limited number of non-overlapping tiles;
partitioning the connectivity of said input IC design according to said tiles; and
creating tile blocks, wherein each of said tile block includes extraction information for performing the RC extraction.

12. The machine-readable medium of claim 11 wherein said operations further comprise:
distributing said tile blocks to a plurality of distributed RC extraction tools;
simultaneously processing said tile blocks by said plurality of distributed RC extraction tools; and
assembling resulting parasitic RC to form a complete parasitic RC model for the IC design.

13. The machine-readable medium of claim 12 wherein the operation of tiling said input IC design comprises:
determining the density of nets in said input IC design;
based on the nets' density determining the position of vertical and horizontal cut lines in the IC design, and thereby forming a plurality of rectangles;
counting the number of terminals in each rectangle;
determining if a maximum number of terminals in each row and each column in the plurality of rectangles are approximately equal; and
repositioning said vertical and horizontal cut lines if said maximum number of terminals in each row and each column in the plurality of rectangles are not approximately equal.

14. The machine-readable medium of claim 13 wherein the rectangles determined by the final position of said vertical and horizontal cut lines are said tiles.

15. The machine-readable medium of claim 11 wherein the operation of partitioning the connectivity of said input IC design comprises:
sorting nets in said IC design to local nets and global nets;
assigning a unique identification (ID) number for each of said local nets and global nets;
assigning a unique ID number for each connection point in each of said local nets and global nets;
identifying exact positions of exit locations of said global nets on boundaries of each of said tiles;
fragmenting each of said global nets into fragments; and
forming a tile net for each exit location and each terminal in each of said global nets inside each of said tiles.

16. The machine-readable medium of claim 15 wherein each of said global nets resides in a respective plurality of said tiles.

17. The machine-readable medium of claim 15 wherein each of said local nets resides within a respective one of said tiles.

18. The machine-readable medium of claim 15 wherein said tile net is assigned with a unique ID number of a respective global net.

19. The machine-readable medium of claim 11 wherein the operation of creating said tile blocks comprises:
for each net in each said tile creating an instance of a tile block;
copying cell and block instances that intersect said tile boundaries to said instance of said tile block;
copying local nets and tile nets inside said tile to said instance of said tile block;
copying nets lie in a halo region of said tile to said instance of said tile block;
copying power and ground planes that intersect said tile to said instance of said tile block; and
copying power and ground planes that intersect said halo region to said instance of said tile block.

20. The machine-readable medium of claim 19, wherein said extraction information includes at least: cell and block instances that intersect the tile boundaries, local nets and tile nets, pieces of nets that lie in a halo region, and parts of the power and ground planes that intersect the tile region or the halo region.

21. A distributed system for accelerating the resistance and capacitance (RC) extraction process of integrated circuit (IC) design, said system comprising:
a main computing node having at least a multi-processing agent for generating tile blocks, wherein each said tile block includes extraction information for performing the RC extraction;
a plurality of remote processing nodes coupled to said main computing node and programmed for simultaneously processing of said tile blocks by a plurality of distributed RC extraction tools; and
a communication network for communication between said main computing node and said plurality of remote processing nodes.

22. The distributed system of claim 21, wherein each of said distributed RC extraction tools is at least a RC extraction tool.

23. The distributed system of claim 21, wherein generating said tile blocks comprises:
tiling an input IC design into a limited number of non-overlapping tiles; and
partitioning the connectivity of said input IC design according to said tiles;
for each net in each said tile creating an instance of a tile block; and
copying extraction information to said tiles.

24. The distributed system of claim 23, wherein said extraction information further comprises:
cell and block instances that intersect the tile boundaries, local nets and tile nets, pieces of nets that lie in a halo region, and parts of the power and ground planes that intersect the tile region or the halo region.
